(19) United States
(12) Patent Application Publication
(10) Pub. No.: US 2025/0247027 A1
(43) Pub. Date: Jul. 31, 2025

(54) TORQUE CONTROLLER, TORQUE CONTROL METHOD, AND DRIVER

(71) Applicants: Motoharu TAKAHASHI, Kanagawa (JP); Yoshihiro TAKAHASHI, Tokyo (JP)

(72) Inventors: Motoharu TAKAHASHI, Kanagawa (JP); Yoshihiro TAKAHASHI, Tokyo (JP)

(73) Assignee: Ricoh Company, Ltd., Tokyo (JP)

(21) Appl. No.: 19/015,019

(22) Filed: Jan. 9, 2025

(30) Foreign Application Priority Data
Jan. 31, 2024 (JP) 2024-013550

(51) Int. Cl. H02P 5/68; B41J 2/515

(52) U.S. Cl. CPC H02P 5/68; B41J 2/515; H02P 2207/05

(57) ABSTRACT

A torque control device includes circuitry. The circuitry is configured to output voltage to each of multiple motors to move a unit, calculate mass of the unit supported by the multiple motors based on the voltage output to each of the multiple motors, and control the torques of the multiple motors based on the mass of the unit calculated.

### CROSS-REFERENCE TO RELATED APPLICATION

This patent application is based on and claims priority pursuant to 35 U.S.C. § 119 to Japanese Patent Application No. 2024-013550, filed on Jan. 31, 2024, in the Japan Patent Office, the entire disclosure of which is hereby incorporated by reference herein.

### BACKGROUND

### Technical Field

The present disclosure relates to a torque control device, a torque control method, and a driver.

### Related Art

A driver known in the art includes a motor disposed on the front side of one unit to raise and lower the front side and another motor disposed on the rear side of the one unit to raise and lower the rear side, and a controller controls the two motors to keep the one unit horizontal. The image forming apparatus includes a driver. In an example of the driver, the controller changes a control method of the motor of a carriage in accordance with an amount of ink in an ink tank and sets the carriage at an appropriate position. As a result, print quality is enhanced, and the difficulty of controlling the carriage drive caused by a demand for overcurrent is prevented.

### SUMMARY

The present disclosure described herein provides a torque control device including circuitry. The circuitry is configured to output voltage to each of multiple motors to move a unit, calculate mass of the unit supported by the multiple motors based on the voltage output to each of the multiple motors, and control the torques of the multiple motors based on the mass of the unit calculated.

The present disclosure described herein also provides a torque control method. The torque control method includes outputting voltage to each of multiple motors to move a unit, calculating mass of the unit supported by the multiple motors based on the voltage output to each of the multiple motors, and setting a gain of each of the multiple motors based on a comparison between an ideal value and the mass calculated.

The present disclosure described herein further provides a driver including multiple motors driving and supporting a unit and a torque control device. The torque control device includes circuitry configured to output voltage to each of multiple motors to move a unit, calculate mass of the unit supported by the multiple motors based on the voltage output to each of the multiple motors, and control the torques of the multiple motors based on the mass of the unit calculated.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of a line head type printer to which a torque controller according to a first embodiment is applied;

FIG. 2 is a schematic diagram of a registration and image forming unit of the line head type printer of FIG. 1;

FIG. 3 is a schematic diagram of a print head array of the line head type printer of FIG. 1;

FIG. 4 is a block diagram of a controller in the line head type printer of FIG. 1;

FIG. 5 is a function block diagram of the controller of FIG. 4;

FIG. 6 is a flowchart of a motor control process in the line head type printer of FIG. 1; and

FIG. 7 is a flowchart of a motor control process in a line head type printer according to a second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to identical or equivalent components and a description of those components may be simplified or omitted.

Embodiments of a torque controller, a torque control method, and a driver are described below in detail with reference to the drawings.

A first embodiment is described below.

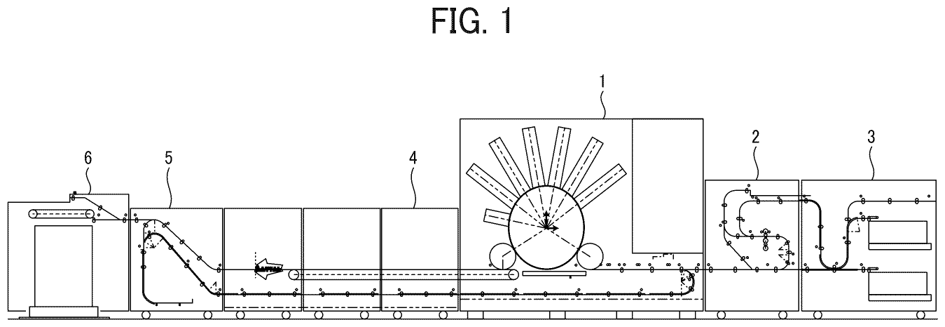

FIG. 1 is a schematic diagram of a line head type printer as a liquid discharge apparatus to which a torque controller according to the first embodiment is applied. As illustrated in FIG. 1, the line head type printer according to the present embodiment includes a registration and image forming unit 1, a pre-coating unit 2, a sheet feeding unit 3, a drying and cooling unit 4, a reversing unit 5, and a sheet ejection unit 6.

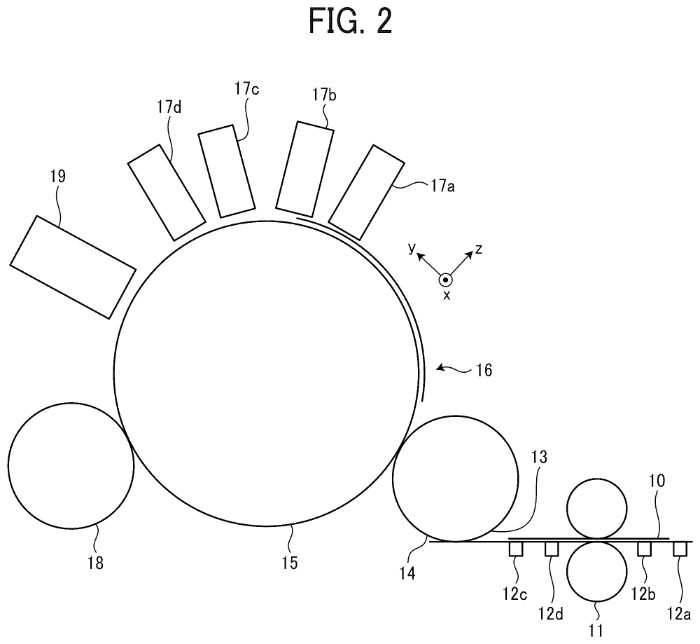

The sheet feeding unit 3 feeds and conveys sheets of paper two by two. The pre-coating unit 2 coats the sheet with an undercoat liquid in advance because fixing ink onto some types of sheets is difficult. The registration and image forming unit 1 detects and corrects the registration and skew of the sheet. After the registration and image forming unit 1 detects and corrects the registration and skew of the sheet, a gripper (a sheet conveyance claw) 13 (see FIG. 2) in the registration and image forming unit 1 delivers the sheet from an entrance cylinder 14 to an image forming drum 15 (see FIG. 2). The entrance cylinder 14 is disposed upstream from the image forming drum 15. In the registration and image forming unit 1, print heads 17a to 17d (see FIG. 2) in a line head print an image on the sheet attracted to the image forming drum 15. In the following description, the print heads 17a to 17d are referred to as the print heads 17 when they are not distinguished from each other.

The drying and cooling unit 4 dries the moisture of the ink. The drying and cooling unit 4 cools the sheet because the temperature of some types of sheets becomes high. The reversing unit 5 performs a switchback reversal operation and conveys the sheet to the registration and image forming unit 1 to form an image on the back side of the sheet. The printed sheet is stacked on the sheet ejection unit 6.

FIG. 2 is a schematic diagram of the registration and image forming unit of the line head type printer of FIG. 1. In the registration and image forming unit 1, edge sensors 12a and 12b detect a positional deviation (and a skew amount) in the main scanning direction before the sheet enters a nip between shift rollers 11. In the registration and image forming unit 1, the shift rollers 11 move to a position facing the sheet in accordance with a detection result of the positional deviation and correct the skew of the sheet in the main scanning direction which has entered the nip between the shift rollers 11.

After the skew is corrected, the edge sensors 12b and 12c (the edge sensor 12d when the size of the sheet is small) detect the positional deviation (and the skew amount) of the sheet in the main scanning direction again in the registration and image forming unit 1 to correct the skew in the main scanning direction, and the gripper 13 attached to the entrance cylinder mechanically opens and closes to grip the leading end of the sheet. The entrance cylinder 14, the image forming drum 15, and an exit cylinder 18 are connected by gears and convey the sheet while changing the grip by the grippers 13 attached to the entrance cylinder 14, the image forming drum 15, and the exit cylinder 18.

The registration and image forming unit 1 includes the print heads 17 for forming a black image (K), a cyan image (C), a magenta image (M), and a yellow image (Y). The print head 17 may be a line head including inkjet heads arranged in an X-axis direction (that is the main scanning direction). The print head 17 discharges ink to form an image when a sheet 10 passes under the print head 17. A controller determines a print timing based on a reference timing at which the sheet passes through the detection area of a print timing sensor 16 in the registration and image forming unit 1. The registration and image forming unit 1 includes an in-line sensor (a scanner) 19 downstream from the print heads 17. The in-line sensor 19 reads an image formed on the sheet. The controller performs a color correction based on results read by the in-line sensor 19.

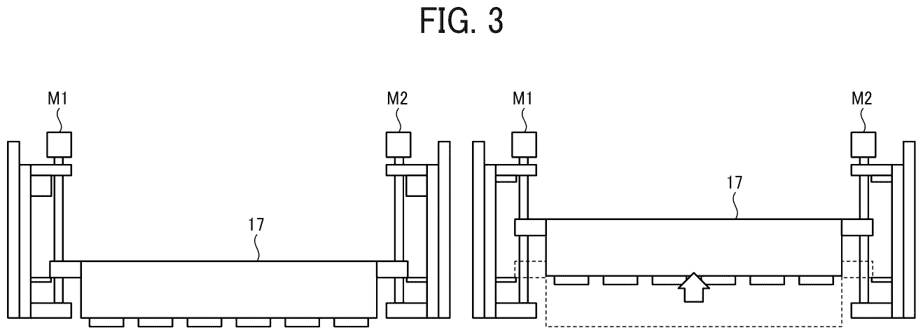

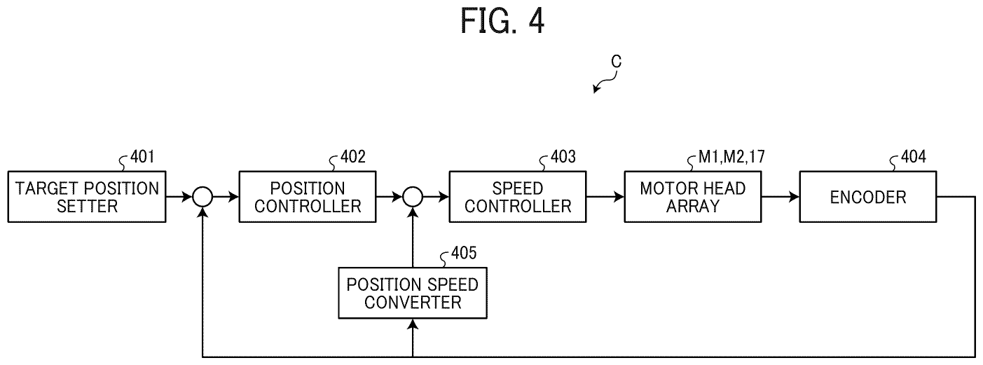

FIG. 3 is a schematic diagram of a print head array of the line head type printer of FIG. 1. FIG. 4 is a block diagram of a controller in the line head type printer of FIG. 1. As illustrated in FIG. 3, the line head type printer as an example of a driver in the present embodiment includes a unit (that is the print head 17 such as the head array including multiple heads) at a center region of the line head printer and a motor M1 adjacent to the left side of the central unit and a motor M2 adjacent to the right side of the central unit. The motor M1 moves the left side of the central unit up and down. The motor M2 moves the right side of the central unit up and down.

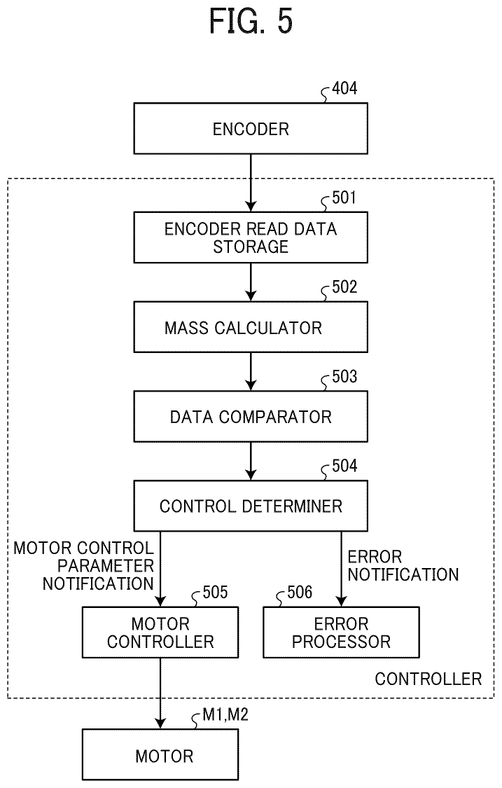

In order to horizontally hold the print head 17, the controller controls the above-described two motors M1 and M2 to adjust the position of the left side of the print head 17 and the position of the right side of the print head 17. As a result, the print head 17 is horizontally held. The print head 17 is an example of the unit and an object to be controlled. The motors M1 and M2 may be direct current (DC) brushless motors. The controller C illustrated in FIG. 4 and FIG. 5 is an example of a torque control device and controls the position of the print head 17 and the speed of the vertical movement of the print head 17. The motors M1 and M2 are examples of multiple motors that drive and support the print head 17. For example, the motors M1 and M2 may be the DC brushless motors or DC brush motors that are driven by direct current voltages or direct currents.

Specifically, the controller C includes a target position setter 401, a position controller 402, a speed controller 403, an encoder 404, and a position speed converter 405. The target position setter 401 sets a target position of the print head 17 (the example of the unit) that is an object to be controlled. The position controller 402 moves the print head 17 to the target position. The speed controller 403 controls the speed of the print head 17 moving toward the target position. The encoder 404 detects the position of the print head 17 and outputs encoder read data identifying the position of the print head. The position speed converter 405 obtains the speed of the print head 17 moving based on the position of the print head 17 indicated by the encoder read data.

FIG. 5 is a function block diagram of the controller as the circuitry of the torque control device of the line head type printer.

The encoder 404 is disposed outside the controller and inputs the encoder read data identifying the position of the object to be controlled (for example, the print head 17) to the controller C.

Specifically, the line head printer includes two encoders. One encoder identifies the position of one end of the print head supported by the motor M1, and the other encoder identifies the position of the other end of the print head supported by the motor M2. The controller controls power supplies to apply voltages slightly higher than voltages determined at the previous control timing to two motors M1 and M2 to raise the print head. The controller determines whether the one end of the print head and the other end of the print head reach target positions based on outputs of the encoders. After the one end of the printer reaches the target position, the controller reduces the voltage applied to the motor M1 so as not to raise the one end of the print head. If the one end of the print head lowers, the controller controls the power supply to increase the voltage applied to the motor M1 to raise the one end of the print head. The controller similarly controls the other motor M2 and adjusts the position of the other end of the print head. Thus, the controller adjusts voltages applied to the motors M1 and M2 based on the outputs of the encoders to stop the one end and the other end of the print head at the target positions.

The controller C includes an encoder read data storage 501, a mass calculator 502, a data comparator 503, a control determiner 504, a motor controller 505, and an error processor 506.

The encoder read data storage 501 stores the encoder read data input to the controller C. Based on the encoder read data and voltages output to the motors, the mass calculator 502 calculates the weight of the object to be controlled (for example, the print head 17) that is stopped. Specifically, the mass calculator 502 calculates the mass of the one end of the print head 17 supported by the motor M1 and the mass of the other end of the print head 17 supported by the motor M2 using the following expressions.

An output current=The voltages output to the motor/a winding resistance.

An output torque=the output current×a torque constant.

Mass=the output torque×a ball screw reduction ratio/the gravitational acceleration.

A sum of the one end and the other end of the print head gives the mass of the print head. The mass calculator 502 is an example of a calculator to calculate the mass of the print head 17 supported by the motors M1 and M2.

The data comparator 503 compares the calculated masses of the object with theoretical values (or ideal values). The theoretical value (or the ideal value) is the mass of a portion of the object supported by each of the motors. For example, if the mass of the object is 200 g, each of two motors supporting the object supports 100 g. In this case, the theoretical value (or the ideal value) is 100 g. However, the theoretical value (or the ideal value) depends on system conditions. Based on the difference between the calculated mass of the object and the theoretical value, the control determiner 504 determines each of control parameters of the motors M1 and M2. The motor controller 505 controls torques of the motors M1 and M2 based on the determined control parameters.

In other words, the data comparator 503 and the control determiner 504 function as an example of a setter to set gains of the motors M1 and M2 based on the comparison of the calculated masses of the print head 17 with the ideal values. Thus, the controller calculates the mass of the one end of the print head 17 supported by the motor M1 based on the voltage output to the motor M1 and the mass of the other end of the print head 17 supported by the motor M2 based on the voltage output to the motor M2 when the object such as the print head 17 is stopped. The controller applies the optimum control setting corresponding to the mass of the one end of the print head 17 to the motor M1 based on the difference between the calculated mass and the theoretical value and applies the optimum control setting corresponding to the mass of the other end of the print head 17 to the motor M2 based on the difference between the calculated mass and the theoretical value. As a result, the controller can drive the motors M1 and M2 with optimum control parameters.

Instead of calculating the real values of the masses as described above, the mass calculator 502 may calculate a ratio of the voltages output to the motors M1 and M2 and multiple the ratio by the theoretical values to calculate the masses supported by the motors. Values other than the ratio of outputs, the ball screw reduction ratio, and the gravitational acceleration among the parameters used to calculate the mass include errors. The calculation of the real mass of the print head 17 involves an error. In order to reduce the influence of the error, using the ratio of the outputs of the motors M1 and M2 reduces the error. The reason why calculating the ratio of the outputs can reduce the errors occurring when the gain is calculated is as follows. the power supply voltage in the above-described calculation is the same voltage because the power supply voltage is supplied from the same power supply. In many cases, the motors M1 and M2 have the same lot with small variations in parameters. As a result, calculating the ratio of the outputs can reduce the errors. The data comparator 503 and the control determiner 504 function as an example of the setter to set gains of the motors M1 and M2 based on the comparison of the calculated masses of the print head 17 with the ideal values.

In response to the difference between the mass of the object and the theoretical value being equal to or greater than a predetermined value, the error processor 506 performs an error stop as an error process that stops the motors M1 and M2. In other words, the error processor 506 is an example of an abnormality detector that detects an abnormality of each of the motors M1 and M2 when the difference between the mass of the object and the theoretical value is equal to or greater than the predetermined value.

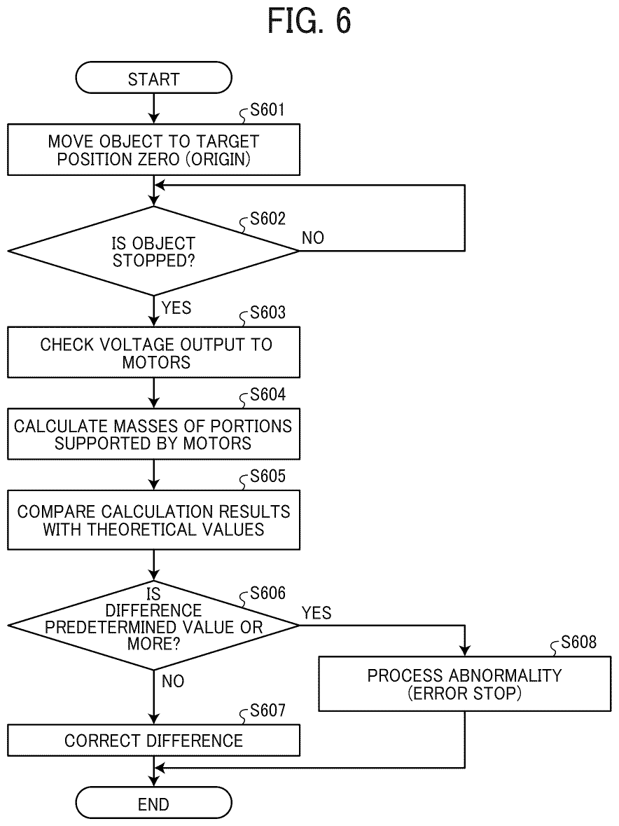

FIG. 6 is a flowchart of a motor control process in the line head type printer according to the first embodiment.

In step S601, the controller C moves the object to be controlled such as the print head 17 to the origin (a target position zero). The controller C controls voltages applied to the motors M1 and M2 so that the one end of the object and the other end of the object stops at target positions. When the object to be controlled is stopped (Yes in step S602), the mass calculator 502 checks the voltage output to the motors M1 and M2 (step S603) and calculates the masses of the portions of the object supported by the motors M1 and M2 (Step S604).

In step S605, the data comparator 503 compares the calculation results of the masses of the objects with the theoretical values. If the difference between the mass of each portion of the objects and the theoretical value is less than the predetermined value (No in Step S606), the control determiner 504 corrects the difference (deviation) and determines the optimal control parameter, and the motor controller 505 controls each of the motors M1 and M2 based on the determined control parameter (Step S607). On the other hand, if the difference between the mass of each portion of the object and the theoretical value is equal to or larger than the predetermined value (Yes in Step S606), the error processor 506 determines that an abnormality has occurred in the object to be controlled and performs the error stop, thereby preventing a failure of the machine (Step S608).

As described above, the controller in the line head type printer according to the first embodiment calculates the masses of the portions of the print head 17 supported by the motors M1 and M2 based on voltages output to the motors M1 and M2 when the object such as the print head 17 is stopped and applies optimum control settings corresponding to the masses of the portions of the print head 17 to the motors based on the differences between the calculated masses and the theoretical values. As a result, the motors M1 and M2 can be driven under the optimum control parameters.

A second embodiment is described below.

In the second embodiment, the controller limits the acceleration of the portion of the object moved by the motor based on the calculated mass of the portion of the print head so that the output current to the motor does not exceed a limit current of the motor. Redundant descriptions of the same components as those in the above-described embodiments may be omitted below.

To keep the print head 17 horizontally, the controller may perform a synchronous control for the two motors M1 and M2 or may separately and independently control the two motors M1 and M2 under the same target. The controller in the second embodiment separately and independently controls the motors M1 and M2.

When the motors M1 and M2 are controlled, the currents output to the motors M1 and M2 may be limited. When the sum of the steady load and the acceleration force applied to each of the motors M1 and M2 exceeds the torque that can be output by each of the motors M1 and M2 through which a limit current flows, the behavior of each of the motors M1 and M2 becomes nonlinear because the output of each of the motors M1 and M2 is the output under the limited current. This deteriorates the followability of the control of the motors M1 and M2 regarding the target positions. In the configuration of the present embodiment, this causes a problem that the print head 17 cannot be maintained horizontally.

Driving the motors M1 and M2 so that the currents output to the motors M1 and M2 do not exceed the limit currents avoids the occurrence of the problem. However, the controller cannot set the currents output to the motors M1 and M2 that are driven by a voltage instruction control. To avoid the occurrence of the problem, the controller in the second embodiment limits the accelerations of the portions moved by the motors M1 and M2 so that the currents output to the motors M1 and M2 have a sufficient margin. However, the advantage of increasing the above-described accelerations is large. For example, increasing the accelerations of the motors M1 and M2 can reduce an operation time. The following describes a technique to avoid the occurrence of the nonlinear behavior of the motors M1 and M2 and reduce the limitations to the accelerations of portions moved by the motors M1 and M2.

In the present embodiment, the motor controller 505 is an example of motor control circuitry that limits the accelerations of the portions moved by the motors M1 and M2 so that the current output to each of the motors M1 and M2 does not exceed the limit current of each of the motors M1 and M2 based on the mass of the portion calculated by the mass calculator 502. Since the above-described controller can limit the above-described accelerations so that the currents output to the motors M1 and M2 have sufficient margins, the nonlinear behaviors of the motors M1 and M2 can be avoided, and the limitations on the accelerations can be reduced. In the mechanism for raising and lowering the print head 17, the above-described control can avoid the print head 17 from being non-parallel due to the power limits of the motors M1 and M2 when the print head 17 is raised.

Alternatively, the motor controller 505 may function as an example of a designation unit that designates a target position of the print head 17 so that the current output to each of the motors M1 and M2 does not exceed the limit current of each of the motors M1 and M2 based on the masses of the print head 17 calculated by the mass calculator 502.

In the present embodiment, when the print head 17 moves up and down at an angle, the mass calculator 502 calculates the mass of the print head 17 based on a torque supporting the vertical component of a force acting on the print head 17.

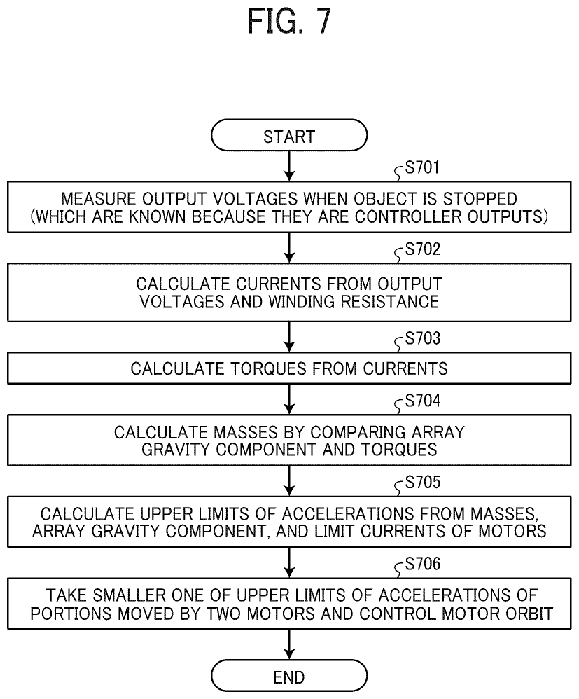

FIG. 7 is a flowchart of a motor control process in the line head type printer according to the second embodiment.

In step S701, the motor controller 505 measures the voltages output to the motors M1 and M2 when the print head 17 is stopped. In step S702, the motor controller 505 calculates the currents output to the two motors M1 and M2 when the print head 17 is stopped. The motor controller 505 calculates the current output to each of the motors M1 and M2 by dividing the difference between the instruction voltage applied to each of the motors M1 and M2 and the voltage due to a counter-electromotive force by the winding resistance.

In step S703, the motor controller 505 calculates torques that are steady loads applied to the motors M1 and M2 (for example, gravity when the print head 17 such as the head array is moved up and down) from the currents output to the motors M1 and M2. In step S704, the motor controller 505 calculates an array gravity component acting on the object to be controlled such as the print head 17 and compares the forces (torque outputs) required for desired and predetermined accelerations of the portions moved by the motors M1 and M2 with the array gravity component to calculate the masses of the portions of the print head 17. In step S705, the motor controller 505 calculates the upper limits of the above-described accelerations based on the masses of the portions of the print head 17, the array gravity component, and the limit currents of the motors M1 and M2. In step S706, the motor controller 505 controls the motors M1 and M2 based on the smaller one of the upper limits of the accelerations of the portions moved by the two motors M1 and M2. That is, the motor controller 505 may designate the target position of the print head 17 when the print head 17 is moved up so that the steady load and the acceleration do not exceed the output current. The motor controller 505 calculates the accelerations of the portions moved by the two motors M1 and M2. Adjusting the target position based on the smaller one of the upper limits of the accelerations that are calculated from the limit currents of the motors M1 and M2 can prevent the followability from being deteriorated due to the limit currents.

As described above, the controller in the line head printer according to the second embodiment performs the measuring process to measure the mass of the object such as the print head 17 when the object is stopped and obtains the acceleration to move the object when the output of each of the motors M1 and M2 is limited. Moving the object with an acceleration equal to or smaller than the acceleration obtained as described above enables maintaining the object horizontally. In addition, the above-described control can move the object within the limit of the acceleration that can be generated by each of the motors M1 and M2.

Aspects of the present disclosure are, for example, as follows.

### <First Aspect>

In a first aspect, a torque controller includes a calculator and a setter. Based on voltages output to multiple motors driving and supporting one unit, the calculator calculates masses of portions of the one unit supported by the multiple motors. Based on a comparison of the mass and an ideal value, the setter sets an optimal gain of each of the motors.

### <Second Aspect>

In a second aspect, a torque controller includes a calculator and a setter. Based on voltages output to multiple motors driving and supporting one unit, the calculator calculates masses of portions of the one unit supported by the multiple motors. Based on a ratio of the voltages output to the multiple motors, the setter sets optimal gains of the motors.

### <Third Aspect>

In a third aspect, a torque controller includes a calculator and a control unit. Based on currents output to multiple motors driving and supporting one unit, the calculator calculates masses of portions of the one unit supported by the multiple motors. Based on each calculated mass, the control unit limits an acceleration of the portion moved by each of the multiple motors such that the current output to each of the multiple motors does not exceed a limit current of each of the multiple motors.

### <Fourth Aspect>

In a fourth aspect, a torque controller includes a calculator and a designation unit. Based on currents output to multiple motors driving and supporting one unit, the calculator calculates masses of portions of the one unit supported by the multiple motors. Based on each calculated mass, the designation unit designates a target position of the portion of the one unit moved by each of the multiple motors such that the current output to each of the multiple motors does not exceed a limit current of each of the multiple motors.

### <Fifth Aspect>

In a fifth aspect, the torque controller according to the first aspect further includes a detector to detect an abnormality when a difference between the calculated mass and the ideal value is a predetermined value or more.

### <Sixth Aspect>

In a sixth aspect, the motor in the torque controller according to any one of the first to fifth aspects is a DC brushless motor or a DC brush motor driven by a voltage.

### <Seventh Aspect>

In a seventh aspect, the motor in the torque controller according to any one of the first to fifth aspects is a DC brushless motor or a DC brush motor driven by a current.

### <Eighth Aspect>

In an eighth aspect, the unit in the torque controller according to any one of the first to seventh aspects moves up and down with an angle, and the calculator calculates the mass based on a torque supporting a vertical component of a force acting on the unit.

### <Ninth Aspect>

In a ninth aspect, a torque control method executed by a torque controller includes calculating, based on voltages output to multiple motors driving and supporting one unit, masses of portions of the unit supported by the multiple motors and setting an optimum gain of each of the multiple motors based on a comparison between each of the calculated masses and an ideal value.

### <Tenth Aspect>

In a tenth aspect, a driver includes a unit, multiple motors driving and supporting the unit, a calculator, and a setter. The calculator calculates masses of portions of the unit supported by the multiple motors based on voltages output to the multiple motors. The setter sets an optimum gain of each of the multiple motors based on a comparison between an ideal value and each of the calculated masses.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. A torque control device comprising
circuitry configured to:
output voltage to each of multiple motors to move a unit;
calculate mass of the unit supported by the multiple motors based on the voltage output to each of the multiple motors; and
control the torques of the multiple motors based on the mass of the unit calculated.

2. The torque control device according to claim 1,
wherein the circuitry is further configured to:
compare the mass of the unit calculated and an ideal value of the mass; and
set a gain of each of the multiple motors based on a comparison between the mass of the unit and the ideal value.

3. The torque control device according to claim 1,
wherein the circuitry is further configured to:
setting gains of the multiple motors based on a ratio of the voltages output to the multiple motors.

4. The torque control device according to claim 1,
wherein the circuitry is further configured to:
calculate an output current output to each of the multiple motors based on the voltage output to each of the multiple motors; and
control the output current to be equal to or smaller than a limit current of each of the multiple motors to control an acceleration of a movement of the unit based on the mass of the unit.

5. The torque control device according to claim 1,
wherein the circuitry is further configured to:
calculate an output current output to each of the multiple motors based on the voltage output to each of the multiple motors; and
control the output current to be equal to or smaller than a limit current of each of the multiple motors to
set a target position of the unit moved by each of the multiple motors based on the mass.

6. The torque control device according to claim 2,
wherein the circuitry is further configured to:
calculate a difference between the ideal value and the mass of the unit; and
perform an error process when the difference is equal to or larger than a predetermined value.

7. The torque control device according to claim 1,
wherein the circuitry is further configured to drive each of the multiple motors by a direct current voltage.

8. A torque control method comprising:
outputting voltage to each of multiple motors to move a unit;
calculating a mass of the unit supported by the multiple motors based on the voltage output to each of the multiple motors; and
setting a gain of each of the multiple motors based on a comparison between an ideal value and the mass calculated.

9. A driver comprising:
multiple motors driving and supporting a unit; and
a torque control device including circuitry configured to:
output voltage to each of multiple motors to move a unit;
calculate mass of the unit supported by the multiple motors based on the voltage output to each of the multiple motors; and
control the torques of the multiple motors based on the mass of the unit calculated.

10. A liquid discharge apparatus comprising:
a head array including multiple heads to discharge a liquid;
multiple motors to support and drive the head array; and
the torque control device according to claim 1 to control torques of the multiple motors.
